(19) United States
(12) Patent Application Publication
(10) Pub. No.: US 2002/0130495 A1
(43) Pub. Date: Sep. 19, 2002

(54) BIAS FLAP FOR SIDE AIR BAGS

(76) Inventors: John Anthony Lotspih, Englewood, OH (US); Laura Adelle Hawthorn, Tipp City, OH (US); Mark Thomas Winters, Troy, OH (US)

Correspondence Address: KATHRYN A. MARRA, DELPHI TECHNOLOGIES, INC., Legal Staff Mail Code: 480-414-420, P.O. Box 5052, Troy, MI, 48007-5052, US

(21) Appl. No.: 09/805,591

(22) Filed: Mar. 13, 2001

(51) Int. Cl. B60R 21/22; B60R 21/16

(52) U.S. Cl. 280/730.2; 280/743.1

(57) ABSTRACT

An air bag module for protection of an occupant within a vehicle during an impact event. The module includes an inflator for generating an inflation gas, an air bag cushion stored in fluid communication with the inflator such that upon generation of the inflation gas the air bag cushion is deployable substantially to the side of the vehicle occupant between the vehicle occupant and the adjacent interior portions of the vehicle. The air bag module further includes a biasing element of flexible character such as a woven or non woven textile which is folded and stored in overlying relation to the air bag cushion. The biasing element is expelled from its stored position upon deployment of the air bag cushion such that the biasing element is disposed between the occupant and the air bag cushion in leading relation to the air bag cushion along the path of deployment of the air bag cushion between the occupant and adjacent interior portions of the vehicle.

### TECHNICAL FIELD

This invention relates to a vehicle air bag assembly, and more particularly, to an air bag assembly for use in the protection of a vehicle occupant during a side impact event.

### BACKGROUND OF THE INVENTION

It is well known in motor vehicles to provide an air bag assembly for the protection of a vehicle occupant. Such air bag assemblies typically include an inflatable cushion structure in fluid communication with a gas emitting inflator. Upon the occurrence of predetermined vehicle conditions, such as deceleration exceeding a certain level, a signal is sent via appropriate sensors to the gas emitting inflator thereby causing the inflator to discharge gas into the air bag cushion forcing the air bag cushion outwardly from a stored position into an operative position between the occupant to be protected and the interior portions of the vehicle against which the occupant might otherwise come in contact. The presence of the inflated air bag cushion between the occupant and the interior portions of the vehicle provides a cushioning effect as the occupant impacts the inflated cushion thereby dissipating the kinetic energy of the occupant in a controlled manner.

It is also known to provide an air bag assembly for the side impact protection of a vehicle occupant. The prior art has disclosed side impact air bag assemblies which have either one cushion or a plurality of cushions which deploy to protect the head and/or the torso portions of a vehicle occupant against impact with the door panels or other side portions of the vehicle interior. Such side air bag cushions are typically deployed from storage positions within the seating structures or door panels of the vehicle.

The performance of side impact air bag assemblies is enhanced when the cushions are deployed in full expanded condition in the region between the occupant to be protected and the side portion of the vehicle interior. Such desired deployment characteristics may be obstructed in the event that the occupant to be protected is positioned outside the borders of the seating structure or is leaning towards the door of the vehicle structure. Thus, in such a situation, the benefits of the side impact air bag assembly may not be fully realized due to the fact that premature contact between the cushion and the occupant prevents the full cushioning character of the air bag to be achieved.

### SUMMARY OF THE INVENTION

The present invention provides advantages and alternatives over the prior art by providing an air bag assembly having an inflatable air bag cushion and further including a biasing element of flexible character which is released from a stored position upon deployment of the air bag cushion so as to promote the desired deployment path of the air bag cushion between the vehicle occupant and adjacent interior portions of the vehicle. If an occupant to be protected is seated or leaning towards the door panel or other interior side portions of the vehicle, the biasing element assists in the insertion of the cushion between the occupant and the door panel such that the occupant may be moved into a more appropriate position as the air bag cushion is deployed. Such expansion thereby permits the effective expansion of the air bag cushion in the region between the vehicle occupant and the adjacent interior portions of the vehicle at the initial stages of deployment. In the event that the occupant is too large or is seated too close to the door panel to permit effective repositioning through insertion and expansion of the air bag cushion, the biasing element provides a deflection surface between the occupant and the air bag cushion which permits the air bag cushion to travel along an alternative deployment path generally rearward of the occupant.

In accordance with a potentially preferred aspect of the present invention, the biasing element may comprise a substantially flat pliable material which may be compactly folded for storage prior to deployment.

Preferably, the biasing element includes a lubricating coating or friction reducing surface treatment across at least a portion of the surface facing the air bag cushion such that the air bag cushion may slide along such surface during deployment.

According to another potentially preferred aspect of the present invention, it is contemplated that the air bag module may be mounted within a seat or in a door panel of the vehicle.

According to yet another potentially preferred aspect of the present invention, the biasing element may be added to an existing air bag module for storage in overlying relation to the air bag cushion within a single containment housing.

Advantageously, the biasing element according to the present invention provides a highly efficient and cost effective means to obtain the desired positional relation between the side impact air bag cushion and the occupant to be protected without the addition of substantial complexity.

In a potentially preferred form of the present invention, an air bag module for protection of an occupant within a vehicle during an impact event is provided. The module includes an inflator for generating an inflation gas, an air bag cushion stored in fluid communication with the inflator such that upon generation of the inflation gas, the air bag cushion is deployable substantially to the side of the vehicle occupant between the vehicle occupant and the adjacent interior portions of the vehicle. The air bag module further includes a biasing element of flexible character such as a woven or non woven textile which is folded and stored in overlying relation to the air bag cushion. The biasing element is expelled from its stored position upon deployment of the air bag cushion such that the biasing element is disposed between the occupant and the air bag cushion thereby clearing a path for deployment of the air bag cushion between the vehicle occupant and adjacent interior portions of the vehicle.

### BRIEF DESCRIPTION OF THE DRAWINGS

The present invention will now be described by way of example only with reference to the accompanying drawings which constitute a part of the specification herein and in which:

FIG. 1 is a perspective view of a vehicle interior partially broken away and including a side impact air bag module in an undeployed state located in a vehicle seat;

FIG. 2 is a cut-away view of an air bag assembly according to the present invention in an undeployed state incorporating a flexible biasing element in stored relation to an inflatable air bag cushion for deployment during a side impact event;

FIG. 3 is a view similar to FIG. 2 but illustrating the biasing element in a deployed position adjacent an immovable severely out of position occupant; and

FIG. 4 is a view similar to FIG. 3 wherein the biasing element is in filly deployed position between the vehicle door panel and repositioned occupant to be protected.

While the invention has been illustrated and generally described above, and will hereinafter be described in detail in connection with certain potentially preferred embodiments and practices, it is to be understood that the foregoing general description as well as the following detailed description and accompanying drawings are intended to be exemplary and explanatory only and in no event is the invention to be limited thereby. On the contrary, it is intended that the present invention shall extend to all alternatives, modifications and equivalents as may embrace the broad principles of this invention within the true spirit and scope thereof

### DESCRIPTION OF THE PREFERRED EMBODIMENT

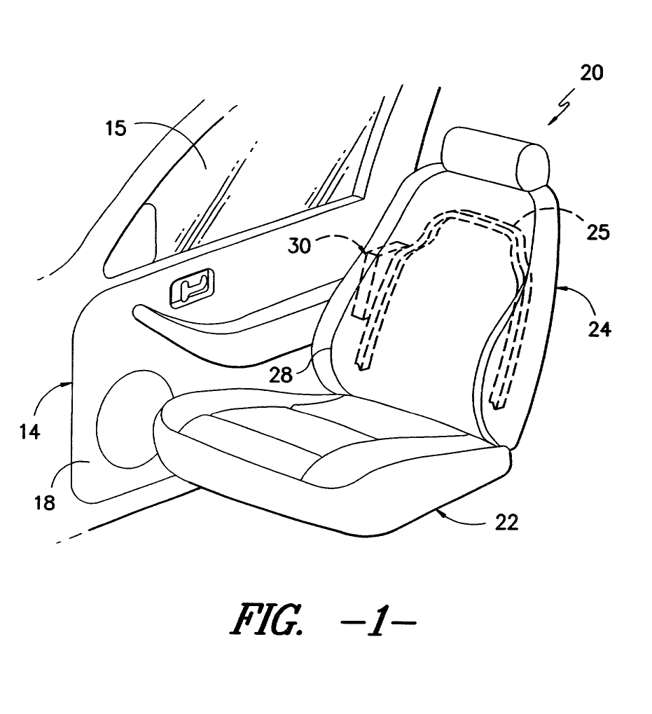

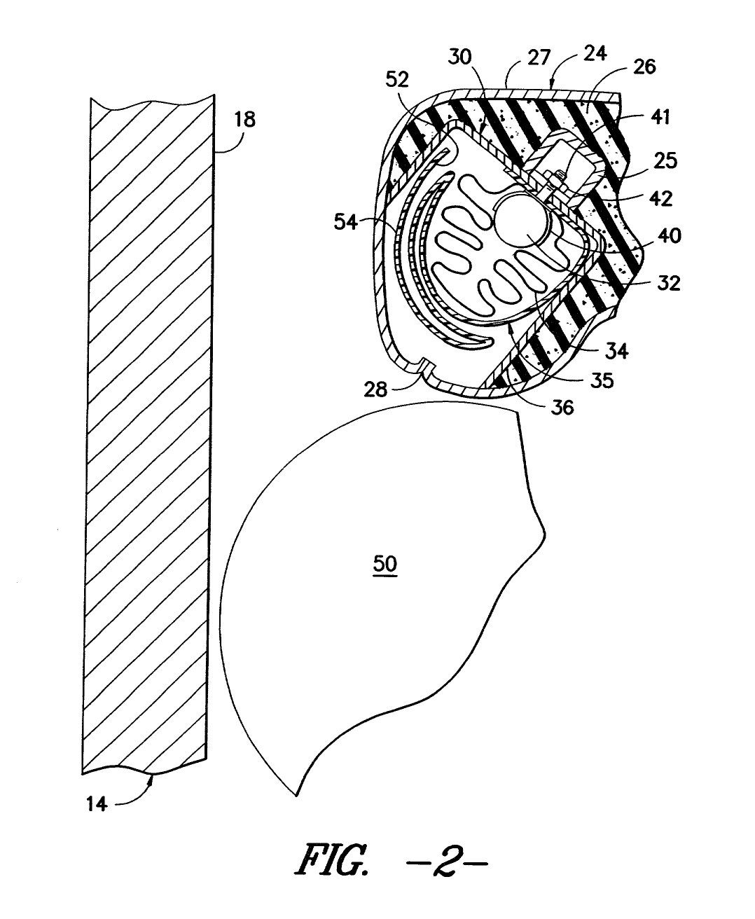

Referring now to the drawings wherein like reference numerals denote like elements throughout the various views, it is seen in FIG. 1 that a vehicle includes a door 14 having a moveable window 15 mounted thereon. The interior of the vehicle includes an inner door panel 18 and a seat 20 for support of a vehicle occupant (not shown). The seat 20 preferably includes a bottom portion 22 and an upwardly extending back portion 24. The back portion 24 includes a rigid seat frame 25 which is preferably made of metal, and encompassed within the back portion 24. As shown in FIG. 2, the back portion 24 is preferably formed of a foam material 26 covered by a fabric or leather seat material 27. The back portion 24 preferably includes a generally vertically extending seat seam 28 which is proximate to the inner door panel 18.

As illustrated through reference to FIGS. 2-4, the component parts of an air bag module 30 according to the present invention are preferably located within the back portion 24 of the seat 20. However, it will be appreciated that the air bag module 30 may alternatively be mounted anywhere in the vehicle. By way of example only, and not limitation, it is contemplated that the air bag module 30 may be well adapted to be mounted in various locations within the seat bottom 22 as well as in the door 14 of the vehicle.

As shown, the air bag module 30 preferably includes an inflator 32, a folded air bag cushion 34 for inflation upon discharge of inflating gas by the inflator 32. The air bag module 30 also preferably includes a flexible folded biasing element 35 which is folded in overlying relation to the air bag cushion 34 and travels outwardly from the module 30 upon deployment of the air bag cushion 34 in leading relation to the travel path of the air bag cushion 34 in a manner to be described further hereinafter. As illustrated, the inflator 32, air bag cushion 34, and biasing element 35 are preferably stored within a housing 36 of plastic or other suitable material. However, it is likewise contemplated that such a housing 36 may be eliminated if desired such that the air bag cushion 34 and biasing element 35 are packed within the seat 20 according to a so-called “soft pack” configuration.

According to a potentially preferred embodiment of the present invention, the inflator 32 is held in place in relation to the seat frame 25 by a mounting bracket 40 in surrounding relation to the inflator 32. The mounting bracket 40 is preferably held in place against the seat frame 25 by appropriate attachment devices such as one or more bolts 41 and cooperatively attached nuts 42 as illustrated. As will be appreciated, such attachment devices may be disposed at various locations along the length of the mounting bracket 40 in surrounding relation to the inflator 32. One such bracket assembly as may be utilized is illustrated and described in U.S. Pat. 5,803,486 to Spencer et al. issued Sep. 8, 1998, the teachings of which are incorporated herein by reference. However, it is contemplated that other attachment mechanisms as may be known to those of skill in the art may likewise be utilized.

The inflator 32 may be of any suitable construction which discharges a gaseous inflation medium upon the existence of predetermined conditions experienced by the vehicle. Such vehicle conditions typically relate to a rapid vehicle deceleration as monitored by appropriate sensors (not shown) as are well known to those of skill in the art. According to the potentially preferred embodiment, the inflator 32 will be of a generally elongate cylindrical configuration permitting mounting along its axial length to the seat frame 25.

The air bag cushion 34 may be made of any suitable material although a textile material of woven or knitted yarns may be preferred. According to a potentially preferred embodiment, the material forming the air bag cushion will preferably be a woven textile formed from nylon or polyester filament yarns wherein such yarns have a linear density in the range of about 105 denier to about 840 denier and most preferably have a linear density of about 630 denier. The filaments which make up such yams are preferably characterized by a linear density of about 3 to about 6 denier per filament. It is believed that such textile structures may provide advantages in packaging the air bag cushion 34 within the confines of the housing 36.

The biasing element 35 is most preferably formed of a woven, knitted or nonwoven textile material of similar nature to the material forming the air bag cushion 34. A textile structure of woven construction formed from nylon yarns having a linear density of about 630 denier may potentially be preferred. However, it is likewise contemplated that any number of other materials and constructions may also be used including woven, knitted, or nonwoven structures formed from other materials such as polyester or other fibers as well as nontextile structures.

The biasing element 35 is preferably of a substantially rectangular configuration having a length dimension which is greater than its height dimension. The biasing element 35 is preferably held in place at one end thereof by the attachment mechanisms utilized to hold the mounting bracket 40 in place with respect to the seat frame 25. Such attachment permits the free extension of the biasing element 35 in its length dimension away from the location of attachment at the mounting bracket 40. The biasing element 35 may thereby be folded upon itself in overlying relation to the air bag cushion 34 within the housing 36 in a manner substantially as illustrated in FIG. 2.

Referring now to FIG. 2, upon the discharge of inflator gas by the inflator 32, such inflator gas travels into the air bag cushion 34 thereby forcing the air bag cushion 34 to exit the housing 36 as expansion takes place. The deployed air bag cushion 34 will preferably assume an operative position between the inner door panel 18 and the space which is occupied by the occupant 50 to be protected. The substantially unimpeded deployment of the air bag cushion 34 between the inner door panel 18 and the occupant 50 to be protected permits the occupant 50 to interact with the substantially fully expanded air bag cushion 34 in a manner which permits the full benefits of the air bag cushion 34 to be realized. However, in the event that there is an obstruction in the region which is to be occupied by the expanded air bag cushion 34, the benefits of the air bag cushion may not be fully realized. Such a situation is represented in FIG. 2 wherein the space which is occupied by the occupant 50 to be protected is abnormally close to the inner door panel 18. In such a situation, the space between the occupant 50 to be protected and the inner door panel 18 may be insufficient to allow for the full beneficial deployment of the air bag cushion 34.

It is believed that to the extent that there exists a sufficient gap between the inner door panel 18 and the space occupied by the occupant 50 to be protected, insertion of the air bag cushion 34 into that gap followed by expansion of the air bag cushion may result in a potentially beneficial lateral repositioning of the occupant 50 and full expansion of the air bag cushion during the remainder of the impact event. However, it is further believed that if the gap between the inner door panel 18 and the space occupied by the occupant 50 to be protected is insufficient to permit substantial insertion of the air bag cushion 34 therein and/or if the occupant 50 is too large to be repositioned without undue force, the continued forced deployment of the air bag cushion in a path between the seat 20 and the inner door panel 18 may not provide the desired benefits. In such a situation, it is believed to be desirable to redirect the deployment path of the air bag cushion 34 into another region of the vehicle.

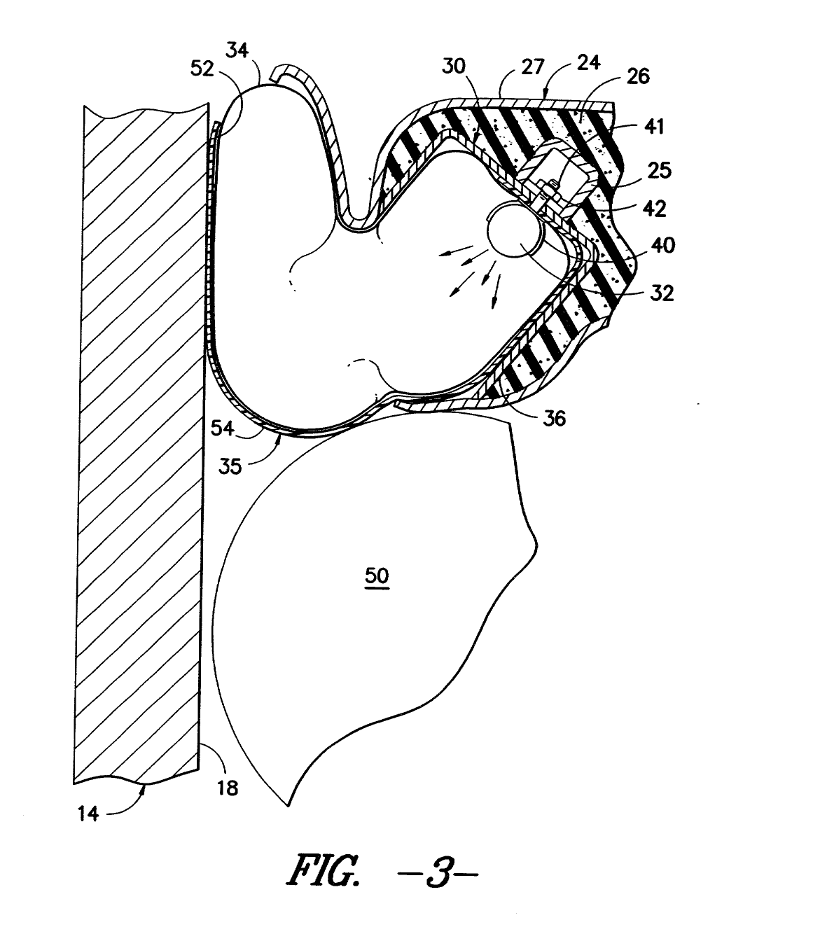

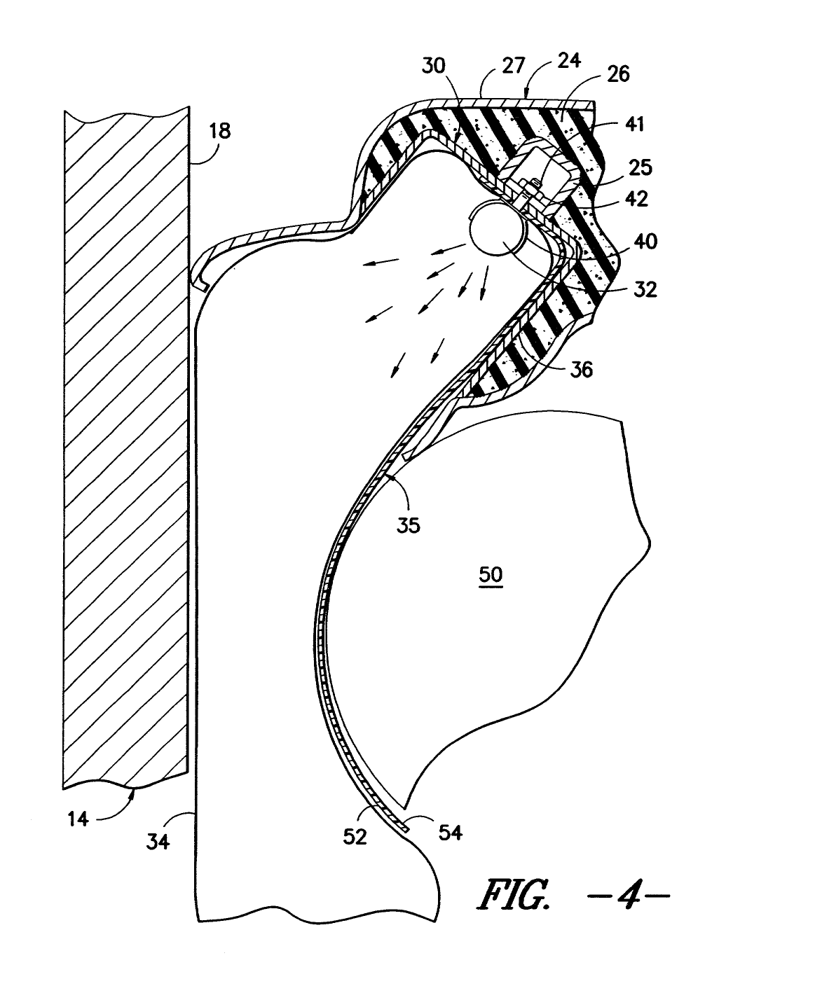

Referring now to FIGS. 3 and 4, according to the present invention, as the air bag cushion 34 initiates deployment through acceptance of inflation gas from the inflator 32, the air bag cushion 34 exits its stored position along with the biasing element 35 such that the biasing element 35 is unfolded so as to extend away from its connection adjacent the bracket 40. Thus, the biasing element is disposed in a substantially curtain-like fashion in leading relation to the air bag cushion along the path of deployment between the inflating air bag cushion 34 and the space which is occupied by the occupant 50 to be protected.

As the deployment of the air bag cushion 34 progresses, the biasing element 35 moves ahead of the expanding air bag cushion 34 in a leading manner thereby providing a barrier between the air bag cushion 34 and the occupant 50 to be protected. In instances when the occupant 50 to be protected is seated in severely close proximity to the inner door panel 18, the presence of the biasing element 35 acts as a deflection surface thereby permitting the air bag cushion 34 to be deflected in a substantially sliding manner along a deployment path substantially rearwardly of the occupant 50 as shown in FIG. 3. Similar deflection likewise takes place in instances wherein the occupant 50 to be protected is too large to be effectively repositioned through the insertion and expansion of the air bag cushion 34 between the inner door panel 18 and the space occupied by the person to be protected. Such redirected deployment thereby permits the air bag cushion 34 to achieve potentially beneficial levels of expansion in an alternative region of the vehicle.

Alternatively, in the event that a gap exists between the door panel 18 and the occupant 50 to be protected which gap is sufficient to permit insertion of the air bag cushion 34 therein, and in the event that the occupant 50 can be repositioned through expansion of the air bag cushion 34 within such gap, the biasing element 35 is believed to enhance the ability of the air bag cushion to slide between the inner door panel 18 and the occupant 50 to be protected thereby effectively pushing the occupant 50 into a more desirable position as the air bag cushion 34 expands to its operative volume as illustrated in FIG. 4. The achievement of such relative positioning is believed to promote the ability of the air bag cushion 34 to provide its full benefit.

As previously indicated, the biasing element 35 is preferably of a substantially flat configuration such that it will have an air bag contact surface 52 across which the air bag cushion 34 moves during deployment. In addition, the biasing element will also have an occupant contact surface 54 which may contact the occupant 50 to be protected as well as the inner door panel 18 during deployment. According to a potentially preferred embodiment of the invention, it is contemplated that the cushion contact surface 52 of the biasing element 35 may be treated in such a manner as to reduce the coefficient of friction between the air bag contract surface 52 and the air bag 34 during deployment. Such a reduction in the friction between the cushion contact surface 52 and the air bag cushion 34 is believed to promote the ability of the air bag cushion 34 to slide across the biasing element 35 during deployment. Such a free sliding relation between the air bag cushion 34 and the biasing element 35 is believed to promote the wedge-like insertion of the air bag 34 between the interior door panel 18 and the occupant 50 to be protected at an early stage of deployment thereby promoting the efficient lateral movement of the occupant 50 away from the interior door panel 18 in a relatively gentle manner. Likewise, in the event that an obstruction is encountered which cannot be moved from the zone to be occupied by the inflated air bag cushion 34, the low friction relation between the biasing element 35 and the air bag cushion 34 is believed to promote the ability of the air bag cushion 34 to be directed around the obstruction due to the sliding relation between the air bag cushion 34 and the cushion contact surface 52 with the biasing element 35 acting as a buffer between the air bag cushion 34 and the immovable obstruction.

In order to provide the potentially desirable degree of reduced friction between the air bag cushion 34 and the cushion contact surface 52 of the biasing element 35, it is contemplated that the cushion contact surface 52 may be at least partially coated with a friction reducing composition. By way of example only, such friction reducing materials may include silicone, TEFLON® or other materials as may be compatible with the surface character of the air bag cushion 34. It is also contemplated that surface treatment methods such as calendering and the like may also be used to provide a smooth low friction cushion contact surface 52 in an uncoated state as may be desired.

In order to promote the buffering performance of the biasing element 35 between the air bag cushion and the occupant to be protected, it is contemplated that the occupant contact surface 54 will preferably be of a relatively high friction character. Such a character permits the occupant contact surface 54 to conform to the contour of the out of position occupant or other obstruction as may be encountered thereby promoting a substantially stable barrier between the air bag cushion 34 and the occupant to be protected. This stability is believed to promote the ability of the air bag cushion 34 to slide over the biasing element 35 into its desired operational position.

In the event that the biasing element 35 is formed from a textile material, it is contemplated that the desired frictional character of the occupant contact surface 54 may be attained by leaving the textile material in an uncoated, untreated state across the occupant contact surface 54. However, it is likewise contemplated that a coating of a tacky material such as neoprene rubber or the like may also be applied across at least a portion of the occupant contact surface 54 to enhance the friction characteristics thereof It is further contemplated that such friction enhancing coatings across the occupant contact surface 54 may be used in conjunction with friction reducing coatings across the air bag contact surface 52 so as to provide cumulative beneficial results.

As will be appreciated, the utilization of the air bag cushion 34 in combination with the biasing element 35 disposed between the air bag cushion 34 and an occupant to be protected during a side impact event provides a practical and cost effective mechanism for promoting the efficiency of the air bag cushion 34. As such, the present invention provides a useful advantage over prior side impact air bag modules. While the present invention has been illustrated and described in relation to potentially preferred embodiments, constructions, and procedures, it is to be understood that such embodiments, constructions, and procedures are illustrative only and that the present invention is in no event to be limited thereto. Rather, it is contemplated that modifications and variations embodying the principles of the present invention will no doubt occur to those of skill in the art to which the invention pertains. It is therefore contemplated and intended that the present invention shall extend to all such modifications and variations as may incorporate the broader aspects of the present invention within the full spirit and scope of the appended claims and all equivalents thereto.

1. An air bag module for protection of an occupant within a vehicle during an impact event, the module comprising:
an inflator for generating inflation gas;
an air bag cushion stored in fluid communication with the inflator such that upon generation of inflation gas, the air bag cushion is deployable substantially to the side of the vehicle occupant between the vehicle occupant and adjacent interior portions of the vehicle; and
a biasing element of flexible character which is released from a stored position upon deployment of the air bag cushion such that the biasing element extends between the occupant and the air bag cushion along the path of travel of the air bag cushion during deployment of the air bag cushion.

2. The invention according to claim 1, wherein the air bag module is mounted within a seat in the vehicle.

3. The invention according to claim 1, wherein the air bag module is mounted within a door frame in the vehicle.

4. The invention according to claim 1, wherein the biasing element comprises a textile material.

5. The invention according to claim 4, wherein the biasing element comprises a textile material of woven construction formed from a plurality of filament yarns.

6. The invention according to claim 5, wherein said filament yarns are characterized by a linear density in the range of about 420 denier to about 840 denier.

7. The invention according to claim 6, wherein said filament yarns are characterized by a filament linear density of not greater than about 6 denier per filament.

8. The invention according to claim 6, wherein said filament yarns are nylon yams.

9. The invention according to claim 6, wherein said filament yarns are polyester yarns.

10. The invention according to claim 1 wherein the biasing element is substantially flat having a first face in facing relation to the air bag cushion upon deployment of the air bag cushion and a second face, extending away from the first face.

11. The invention according to claim 10, wherein a lubricating coating extends across at least a portion of the first face of the biasing element thereby promoting a sliding relation between the air bag cushion and the first face of the biasing element.

12. The invention according to claim 10, wherein a friction enhancing coating extends across at least a portion of the second face of the biasing element.

13. The invention according to claim 10, wherein a lubricating coating extends across at least a portion of the first face of the biasing element and a friction enhancing coating extends across at least a portion of the second face of the biasing element.

14. The invention according to claim 10, wherein the first face of the biasing element comprises a substantially smooth uncoated surface.

15. An air bag module for protection of an occupant within a vehicle during an impact event, the module comprising:
an inflator for generating inflation gas;
an air bag cushion comprising a textile material formed from a plurality of interwoven nylon filament yarns wherein said nylon filament yarns are characterized by a linear density of about 210 denier to about 630 denier, the air bag cushion stored in folded relation within a storage chamber in fluid communication with the inflator such that upon generation of inflation gas, the air bag cushion is deployable from the storage chamber substantially to the side of the vehicle occupant between the vehicle occupant and adjacent interior portions of the vehicle; and
a biasing element of flexible character stored in overlying relation to the air bag cushion within the storage chamber such that upon deployment of the air bag cushion the biasing element extends between the occupant and the air bag cushion during deployment of the air bag cushion.

16. The invention according to claim 15, wherein the air bag module is mounted within a seat in the vehicle.

17. The invention according to claim 16, wherein the biasing element comprises a textile material of woven construction formed from a plurality of nylon yarns.

18. The invention according to claim 17, wherein said nylon yarns are characterized by a linear density in the range of about 420 denier to about 840 denier.

19. The invention according to claim 15, wherein the biasing element is substantially flat having a first face in contacting relation to the air bag cushion upon deployment of the air bag cushion and a second face extending away from the first face.

20. The invention according to claim 19, wherein a friction reducing coating extends across at least a portion of the first face of the biasing element.

21. The invention according to claim 20, wherein a friction enhancing coating extends across at least a portion of the second face of the biasing element.
